(19) United States
(12) Patent Application Publication
(10) Pub. No.: US 2011/0006005 A1
(43) Pub. Date: Jan. 13, 2011

(54) DESALINATION SYSTEM AND METHOD

(75) Inventors: Allan Robert Thomson, Inverness (GB); Richard Morris, Glasgow (GB)

Correspondence Address: MOORE & VAN ALLEN PLLC, P.O. BOX 13706, Research Triangle Park, NC, 27709, US

(73) Assignee: Aquamarine Power Limited, Glasgow (GB)

(21) Appl. No.: 12/781,456

(22) Filed: May 17, 2010

Related U.S. Application Data
(60) Provisional application No. 61/179,129, filed on May 18, 2009.

(51) Int. Cl. B01D 61/06; C02F 1/44

(52) U.S. Cl. 210/652; 210/170.11

(57) ABSTRACT

A desalination system comprises a reverse osmosis device, a pump for pressurizing fluid to be desalinated, a supply conduit for supplying the pressurized fluid to the reverse osmosis device, and a wave power system for driving operation of the pump, wherein the wave power system comprises a turbine connectable to a transmission for driving operation of the pump and arranged such that in operation rotation of the turbine provides mechanical energy to the transmission to drive operation of the pump; and a wave energy conversion device connectable to a turbine fluid supply conduit for supplying fluid to the turbine, wherein the wave energy conversion device is arranged to operate in response to wave motion to transfer fluid through the turbine fluid supply conduit to drive rotation of the turbine.

### CROSS-REFERENCE TO RELATED APPLICATIONS

This application claims priority from U.S. Provisional Patent Application No. 61/179,129, filed May 18, 2009 and entitled: “A desalination system and method”, the contents of which are also hereby incorporated herein by reference.

### FIELD OF THE INVENTION

The present invention relates to a power system, and in particular to a power system suitable for providing power to a desalination apparatus.

### BACKGROUND TO THE INVENTION

Some known desalination systems comprise reverse osmosis devices that include reverse osmosis membranes. Pressurized sea-water or other fluid to be desalinated is filtered, pressurized and passed through the membrane to produce desalinated water and a by-product of pressurized, concentrated brine.

Reverse Osmosis desalination systems are power hungry as they require large amounts of power to drive operation of pumps to pressurize the fluid to be desalinated. Furthermore, desalination systems are often in relatively remote locations, away from electrical grid connections and so dedicated power lines may have to be provided.

There has been considerable debate concerning the perceived high energy consumption of desalination plants, and associated environmental concerns. For example, in Australia companies planning to build desalination plants are required to obtain renewable energy certificates from companies that generate renewable energy, in amounts equivalent to the energy consumption of the desalination plants.

The concept of using renewable energy either directly or indirectly in the operation of desalination plants is gaining acceptance in environmentally aware regions of the world. In London, there has been a commitment to proceed with a desalination plant only if it is powered with renewable energy, and it likely that environmentally aware countries planning desalination plants in the future will impose similar requirements.

With the interest in renewable energy, various wave energy conversion devices have been developed. Many such wave energy conversion devices operate by using wave motion to pressurize fluid, which pressurized fluid in turn is used to drive operation of an electrical generator to produce electrical power.

As most desalination systems are located next to the sea, it has been suggested that the electrical power for driving the pumps to pressurize sea-water to be desalinated may be provided by wave energy conversion devices. The possibility of utilizing wave energy for desalination could result in some cases in the desalination plant being located near a reliable wave energy source. At the moment this is not a factor in desalination plant site selection.

However, the process of converting wave power to electrical power is relatively inefficient. Furthermore, the electrical power generation system used to provide electrical power from wave power provides an additional installation and maintenance burden, which can be onerous, particularly as many desalination plants are located in relatively remote locations. In addition, wave energy conversion devices do not provide a constant electrical power output, due to the variable nature of the wave environments, and there can be periods where insufficient electrical power is provided to enable operation of the desalination system. For example, in most areas wave energy is at a minimum over the summer months when water consumption is at its highest. Furthermore, there may be periods of extended calm when wave energy is not available. Water storage can be used to reduce such problems by may require huge investment, and may not be possible in practice. In light of those issues, the use of wave power alone to power autonomous desalination plants presents significant challenges.

As an alternative to using a wave energy conversion device to provide electrical power to drive operation of the desalination system it has been suggested that wave energy conversion devices can be used to pressurize directly sea-water for supply to the membranes of a reverse osmosis device. From the point of view of energy consumption, such a direct pressure system is favorable as pressurized fluid from the wave energy conversion device is fed directly to the membrane without the need for intermediate energy conversion stages.

However, there are a number of disadvantages to providing pressurized sea-water directly from a wave energy conversion device to a reverse osmosis desalination system. For example, there are significant operational and maintenance difficulties in supplying pressurized sea-water to the filtering and other pre-treatment stages of the system. At present, filtering and other pre-treatment is performed prior to pressurization. Major infrastructural changes would be required to convert existing reverse osmosis desalination systems to enable the use of directly pressurized sea-water, which may require prolonged shutdown and suspension of water supply.

Furthermore, the use of a wave energy conversion device would inevitably in practice result in the provision of sea-water at fluctuating pressures and flow rates to the membrane of the reverse osmosis desalination system. On one hand, membrane manufacturers usually specify a minimum water flow through membranes at all times to eliminate scale formation and minimize membrane fouling. On the other hand provision of water at excessive pressures or flow rates, due for example to wave power surges, is likely to damage membranes. In addition, continuous variations in pressure and flow rates (even within a normal operating range) may disrupt effective operation of the desalination process.

Another concern associated with the possible low-pressure of the sea-water supply (for example, arising from calm sea conditions) is that water produced by the desalination system at pressures close to the osmotic pressure of sea-water (approximately 25 bar) would not be suitable as potable water because of its high salt content. Such water would have to be discarded with consequential increase in cost of the production of water of acceptable quality. In addition, the rate of production of water of acceptable quality would be a direct function of sea conditions (which vary strongly with the seasons), whereas rates of water consumption are generally stable. That may produce a requirement for storage of water produced during active periods, which can be expensive particularly in hot, dry environments, and a non-utilization of equipment during quiet periods resulting in increased capital water cost.

It is desirable to provide a power system for desalination systems that uses wave or sea power, but that provides acceptable and consistent rates of water production. It is also desirable to provide such a power system that may be incorporated easily into existing desalination systems.

### SUMMARY OF THE INVENTION

In a first, independent aspect of the invention there is provided a desalination system comprising a reverse osmosis device, a pump for pressurizing fluid to be desalinated, a supply conduit for supplying the pressurized fluid to the reverse osmosis device, and a wave power system for driving operation of the pump, wherein the wave power system comprises:—a turbine connectable to a transmission for driving operation of the pump and arranged such that in operation rotation of the turbine provides mechanical energy to the transmission to drive operation of the pump; and a wave energy conversion device connectable to a turbine fluid supply conduit for supplying fluid to the turbine, wherein the wave energy conversion device is arranged to operate in response to the wave motion to transfer fluid through the turbine fluid supply conduit to drive rotation of the turbine.

By providing a wave power system including a turbine that is arranged to provide mechanical energy to drive operation of the pump, the desalination system may be powered in a particularly efficient manner, without requiring the intermediate conversion of mechanical energy to electrical energy. Furthermore, by using the turbine to provide mechanical energy directly to the transmission, a particularly simple system may be provided, which may be readily obtained by retrofitting or otherwise adapting existing equipment.

The system may further comprise a motor for at least partially driving operation of the pump. By providing a motor in addition to the wave power system, greater flexibility and control may be provided over the rate of operation of the pump. In particular, the motor can provide backup power or can compensate for any shortfall in power provided by the wave power system. That feature can be particularly important due to the intrinsically variable nature of the power output from the wave power system.

The transmission may be a common transmission for both the motor and the turbine, and both the motor and the turbine may be operably connectable to the transmission. By providing a common transmission for both the motor and the turbine, a particularly simple system may be provided. The common transmission may comprise a common shaft for both the motor and the turbine.

The system may further comprise control means (for example a controller) for controlling the amount of power supplied to the pump by the motor and/or the amount of power supplied to the pump by the turbine. By providing such a control means, the amount of power supplied to the pump may be controlled accurately despite any variations in power available from the turbine, or any power restrictions of the motor. The control means may control the amount of power directly or may control one or more other parameters that are representative of or associated with the amount of power.

The control means may be configured to control the amount of power supplied by the motor to the pump and/or the amount of power supplied by the turbine to the pump to provide at least one of: a desired torque; a desired rate of rotation of the pump; a desired pressure of the pressurized fluid supplied to the reverse osmosis device; and a desired rate of flow of pressurized fluid to the reverse osmosis device. Thus, the system may be controlled to ensure that the reverse osmosis device operates within a desired range of operating conditions.

The desired torque, the desired rate of rotation, the desired pressure and/or the desired rate of flow may be a predetermined torque, a predetermined rate of rotation, a predetermined pressure and a predetermined rate of flow. Each of the desired torque, the desired rate of rotation, the desired pressure and/or the desired rate of flow may be substantially constant and/or may be within a respective predetermined range.

The substantially constant value or predetermined range of the desired torque, the desired rate of rotation, the desired pressure and/or the desired rate of flow may be selected to provide a desired rate of production of desalinated fluid.

The system may further comprise monitoring means for monitoring the amount of power supplied to the pump by the turbine and/or for monitoring the amount of power supplied to the pump by the motor. The monitoring means may monitor the amount of power directly, or may monitor one or more other parameters that are representative of or associated with the amount of power. The monitoring means may comprise or form part of the controller, or may be separate from the controller. The monitoring means may comprise a processing resource, for example a suitably programmed processor.

The control means may be configured to control the level of power supplied to the pump by one of the motor and the turbine to make up a shortfall in power supplied to the pump by the other of the motor and the turbine. Thus, the control means may ensure that any variation in power supplied by one of the motor and the turbine may be compensated by a corresponding variation in power supplied by the other of the motor and the turbine.

The control means may be configured to control the level of power supplied by the motor and/or the turbine to ensure that the rate of change of power supplied by the motor and/or the turbine is within a predetermined threshold. The control means may ensure that the rate of change of power is within a predetermined ramp rate. By controlling the rate of change of power it may be ensured that the motor (or the wave power system) does not stall or otherwise operate outside recommended operating conditions.

The system may further comprise an electrical generator that is operably connectable to the turbine to generate electricity from rotation of the turbine. Thus, a desalination plant operator may generate electrical power and sell surplus power to the grid, and/or use the electrical power to power other equipment on the plant. The electrical generator may be operably connectable to the turbine via the transmission or via a further transmission.

The control means may be configured to connect the turbine to the electrical generator to generate electricity from excess rotational energy of the turbine. The motor may be configured to operate as the electrical generator.

The turbine may comprise an impulse turbine. The turbine may comprise a Pelton wheel. A Pelton wheel is particularly efficient and easy to install and operate.

The system may further comprise a flywheel for storing rotational energy provided by the turbine. The system may further comprise at least one control valve for controlling flow of fluid from the turbine fluid supply conduit to the turbine.

The control valve or at least one of the control valves may comprise a variable opening control valve, and the system may further comprise a flow controller for varying the opening of the variable opening control valve during each wave cycle.

The flow controller may be configured to vary the opening of the variable opening control valve during each wave cycle so as to reduce the variation in the rate of rotation of the turbine during each wave cycle and/or to increase the efficiency of operation of the turbine. The flow controller may be or form part of the controller.

The fluid supplied to the turbine may be salinated fluid, the turbine may comprise an output for expelling the salinated fluid, and the turbine output may be connected to an input to the desalination system, whereby in operation salinated fluid expelled from the turbine is passed to the desalination system for desalination. Thus, the wave energy conversion device may fulfill the dual role of driving operation of the pump and of supplying fluid to be desalinated to the desalination system. The salinated fluid may be sea water.

In another independent aspect of the invention, there is provided a method of desalination that comprises using a wave energy conversion device to drive rotation of a turbine, and using mechanical energy from the turbine to drive operation of a pump to pressurize fluid to be desalinated.

In a further independent aspect of the invention there is provided a method of adapting a desalination system, the desalination system comprising a reverse osmosis device, a pump for pressurizing fluid to be desalinated, a supply conduit for supplying the pressurized fluid to the reverse osmosis device, and a motor for driving operation of the pump, wherein the method comprises:—providing a turbine connectable to a transmission for driving operation of the pump and arranging the turbine such that in operation rotation of the turbine provides mechanical energy to the transmission to drive operation of the pump; and providing a wave energy conversion device connectable to a turbine fluid supply conduit for supplying fluid to the turbine, and arranging the wave energy conversion device to operate in response to wave motion to transfer fluid through the turbine fluid supply conduit to drive rotation of the turbine.

In further independent aspect there is provided a system substantially as described herein with reference to the accompanying drawings, and a method substantially as described herein with reference to the accompanying drawings.

Any feature in one aspect of the invention may be applied to other aspects of the invention, in any appropriate combination. In particular, apparatus features may be applied to method features and vice versa.

### BRIEF DESCRIPTION OF THE DRAWINGS

At least one embodiment of the invention will now be described, by way of example only, with reference to the accompanying drawings, in which:

FIG. 1 is a schematic illustration of a desalination system according to an embodiment;

FIG. 2 is a schematic illustration of a desalination system according to another embodiment;

FIG. 3 is an schematic illustration of a wave power system for use with the embodiments of FIGS. 1 and 2;

FIG. 4 is a graph of efficiency versus flow rate for various types of turbine; and

FIG. 5 is a graph of efficiency versus load for an electric motor.

### DETAILED DESCRIPTION OF EMBODIMENTS

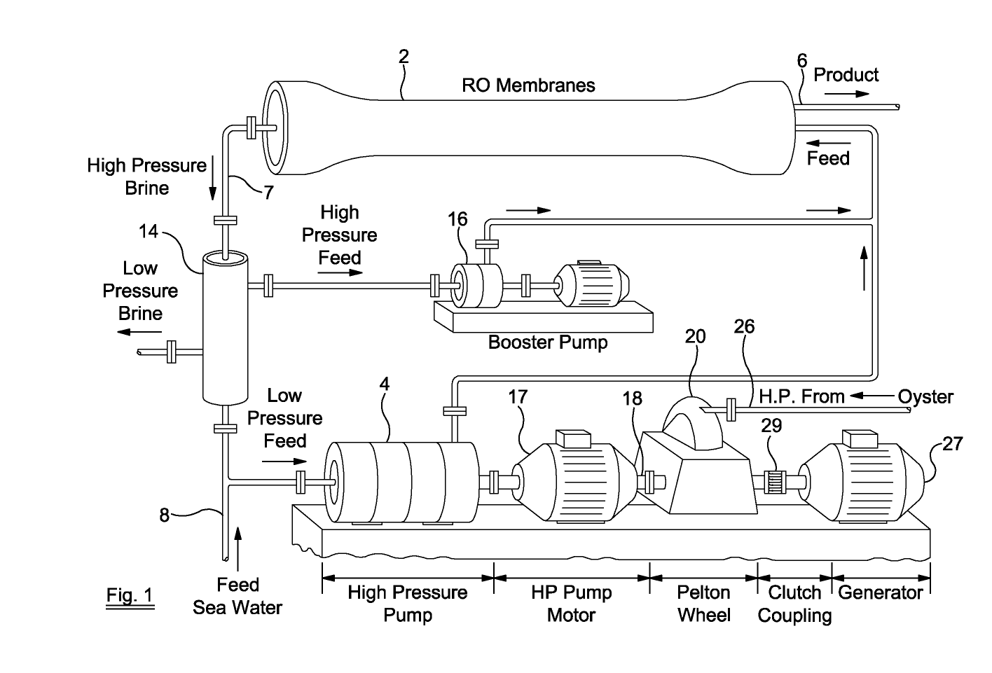

Embodiments of the present invention are now described, by way of example only. FIG. 1 is a schematic diagram of a desalination system according to one embodiment. The system comprises a reverse osmosis device 2 that is connected on the input side to a high pressure pump 4 for supplying water to be desalinated. The reverse osmosis device 2 is connected on the output side to an outlet 6 that outputs desalinated water and to a waste water output 7 that outputs concentrated brine.

The high pressure pump 4 is connected to a water supply input 8 that provides water to be desalinated, via a low pressure pre-treatment system (not shown) for filtering and otherwise pre-treating water to be desalinated, to remove suspended solids and marine organisms which may foul the membrane of the reverse osmosis device 2. The pre-treatment system comprises multi-media sand filters and cartridge filters.

The waste water output 7 of the reverse osmosis device 2 is connected to a pressure exchanger 14 that also takes a feed from the water supply input 8. The output of the pressure exchanger 14 is connected to the input of the reverse osmosis device 2 via a booster pump 16.

The high pressure pump 4 is connected to an electric motor 17 via a transmission that comprises a drive shaft 18. A turbine device in the form of a Pelton wheel 20 is connected to the drive shaft 18. The Pelton wheel 20 forms part of a wave power system that also comprises a wave energy conversion device that is connected to a turbine fluid supply conduit 26 for supplying fluid to the Pelton wheel 20. A controller (not shown in FIG. 1) is connected to the electric motor 17 and to the wave power system 22. The controller 28 is connected to sensors (not shown) associated with the electric motor 17 and the wave power system 22.

The various sensors are configured to measure various operating properties of the motor and the wave power systems, for example rates of rotation, torques, and pressures of fluid within the system. A wide variety of sensors are known for these purposes, and any suitable type of sensors may be used, for example pressure sensors manufactured by Keller, and torque or rotation sensors manufactured by ABB. Any suitable type of controller can be used, for example any suitable type of programmable logic controller. For example, an Allen Bradley programmable logic controller may be used. Alternatively, the controller may comprise a suitably programmed computer, for example a PC, or may comprise dedicated task-specific hardware, for example one or more ASICs. The motor may be any suitable type of electric motor, for example a suitable electric motor manufactured by ABB. The Pelton wheel may be any suitable Pelton wheel, for example manufactured by Calder AG. Similarly the reverse osmosis device may be any suitable reverse osmosis device, for example manufactured by Calder AG.

An electrical power generator 27 is also connectable to the drive shaft 18 via a clutch coupling 29, and may be driven by the rotation of the Pelton wheel 20. Any suitable type of generator may be used, for example an ABB 350 kW generator.

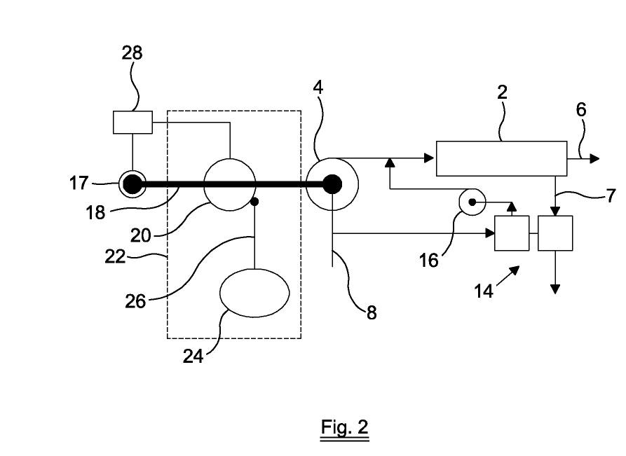

A variant of the embodiment of FIG. 1 is illustrated in FIG. 2, in which like components are indicated by like reference numerals. In the embodiment of FIG. 2, the generator 27 is omitted. The controller 28 is illustrated schematically in FIG. 2, as is the wave energy conversion device 24 and the wave power system 22.

In another variant, the water supply to the reverse osmosis device is taken from a beach well. A well pump is used to pumping sea-water from the beach well. The sea-water from the beach well is filtered naturally by the local ground strata, and additional filtering is provided by the pre-treatment system that includes multi-media sand filters and cartridge filters. By using water from beach wells, the use of chemicals in the pre-treatment system can be reduced, the cleaning intervals for the multi-media filters and cartridge filters can be extended and the life of the membranes of the reverse osmosis device can be increased. However, in some cases the local geology is not suitable for the use of beach wells.

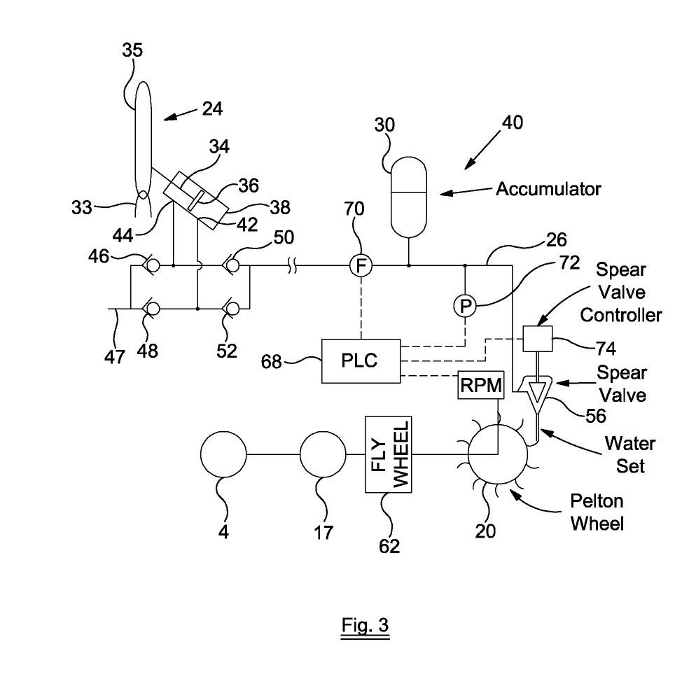

Various different types of wave energy conversion devices 24 and various different wave power systems may be used to drive operation of the turbine using wave energy. The power system used in the embodiment of FIG. 1, including one example of a suitable wave energy conversion device 24, is illustrated in FIG. 3.

As shown in FIG. 3, the wave energy conversion device 24 is coupled by a suitable linkage and a driving rod 34 to a hydraulic ram (piston) 36 which reciprocates in a cylinder 38 and is double acting.

The cylinder 38 forms part of a hydraulic circuit 40 to which it is connected by an inlet/outlet port 42 at one end of the cylinder, an inlet/outlet port 44 at the opposite end of the cylinder 38, and an arrangement of non-return valves 46, 48, 50, 52.

The wave energy conversion device 24 comprises a base portion 33 anchored to the bed of the sea or other body of water and an upstanding flap portion 35, of generally rectangular form, mounted for rotation about a pivot axis to the base 33. An example of a suitable wave energy conversion device 24 is described, for example, in WO 2006/100436. In operation the flap portion 35 is placed to face the direction of wave motion, and the wave motion causes the flap portion to oscillate about the pivot axis, which in turn drives the ram 36 back and forth in the cylinder 38.

In operation, the ram 36 is driven backwards and forwards in the cylinder 38 by oscillation of the flap portion 35 caused by the wave motion. On each forwards stroke of the ram, low pressure sea water from inlet pipe 47 is drawn into the cylinder 38 through port 44 via non-return valve 46, and high pressure sea water is pumped out of the cylinder 38 through port 42 and non-return valve 52 into the fluid conduit 26. On each backwards stroke of the ram, low pressure sea water from inlet pipe 47 is drawn into the cylinder 38 through port 42 via non-return valve 48, and high pressure sea water is pumped out of the cylinder 38 through port 44 and non-return valve 50 into the fluid conduit 26.

The fluid conduit 26 forms part of the hydraulic circuit 40 and connects the outlets 42, 44 of the cylinder 38 to a pair of spear valves 56 (only a single spear valve is shown for clarity). The spear valves 56 are aligned with the Pelton wheel 20. The Pelton wheel 20 comprises a number of cups (also referred to as buckets) attached to the periphery of a wheel. The high-pressure water from one or more nozzles of the valves 56 hits the buckets on the wheel converting the hydraulic pressure of the water into rotational mechanical energy at the wheel's shaft 18, and driving rotation of the Pelton wheel 20. The opening of the spear valves may be controlled during each wave cycle in order to reduce the variation in the rate of rotation of the Pelton wheel 20 during each wave cycle and in order to ensure that the Pelton wheel 20 is operating efficiently.

The hydraulic circuit of the system of FIG. 1 is an open circuit, in that the sea water is not returned to the system after it has exited the Pelton wheel, but instead is passed back into the sea via a drainage conduit (not shown). In an alternative embodiment, the sea water is passed to the sea water input 8 of the desalination system for pressurization and desalination by the reverse osmosis device 2. Thus, the wave energy conversion device can play the dual role of providing mechanical power for driving operation of the pump and supplying sea water for desalination. In another alternative embodiment, the hydraulic circuit is a closed circuit and the hydraulic fluid is discharged from the Pelton wheel 20 into a storage or buffer tank, from where it is returned to the inlet pipe 47 via a return conduit. The hydraulic fluid may be water, for example fresh water.

An accumulator 30, comprising a pressure cylinder containing air, is connected to the fluid conduit 26 between the non-return valves 50, 52 and the spear valves 56. As fluid is pumped out of the cylinder 38 into the fluid conduit 56 the air is compressed to store some of the pressure produced by the pumping action of the ram 36. This has the effect of smoothing variations in the pressure of the fluid in the fluid conduit 56 that is delivered to the Pelton wheel 20. The Pelton wheel 20 may be connected to a flywheel 62, which can also operate to smooth out to some extent variations in the rate of rotation of the Pelton wheel 26 during each wave cycle. Flow and pressure meters 70, 72 are provided in the fluid conduit 26. A flow controller 68 is connected to and obtains outputs from the meters 70, 72 and controls the opening of the spear valves 56 in dependence on the outputs from the meters 70, 72. The flow controller 68 can be in communication with and controlled by the controller 28.

In operation, water to be desalinated is provided to the high pressure pump 4 from the water supply input 8. The high pressure pump 4 pumps the pre-treated water at a desired input pressure to the reverse osmosis device 2. The water passes through the reverse osmosis device under pressure and is desalinated and output via the outlet 6. A by-product of concentrated brine is output via the waste water output 8 to the pressure exchanger 14.

The concentrated brine is still at a relatively high pressure when it is output from the reverse osmosis device 2. The pressure exchanger 14 operates to use the pressurized brine to pressurize water to be desalinated that is fed to the pressure exchanger 14 from the water supply input 8. The resulting pressurized water is further pressurized to the desired input pressure of the reverse osmosis device 2 by the booster pump 16 and is then passed to the input of the reverse osmosis device 2 together with the water output by the high pressure pump 4.

In order to operate most effectively, the pressure and flow rate of the water supplied to the reverse osmosis device 2 should usually be within a predetermined range. If the pressure is too low, desalination may not occur, and if the flow rate is too low then scale can build up on the membrane or the membrane can otherwise become fouled. If the pressure or flow rate is too high then damage can be caused to the membrane. Furthermore, short term fluctuations of pressure or flow rate, even around acceptable values, can cause damage to the membrane or interfere with effective operation of the desalination process. Ideally, the pressure and flow rate of the water to be desalinated provided to the reverse osmosis device is substantially constant, and thus provides a substantially constant rate of output of desalinated water.

The pressure can be controlled by controlling the rate of operation of the high pressure pump, which in turn can be controlled by controlling the torque applied to the drive shaft 18. In the preferred embodiments, torque can be applied to the drive shaft by both or either the electric motor 17 and the Pelton wheel 20. The Pelton wheel 20 is mechanically connected to the pump 4 and drive shaft 18 and transmits mechanical energy that alleviates the load on the electric motor 17, either wholly or completely. Thus, wave power can be used to power the desalination apparatus either wholly or completely.

As discussed above in relation to FIG. 3, the motion of the waves drives motion of the wave power conversion device, which forces hydraulic fluid through the turbine fluid supply conduit 26 and onto the Pelton wheel 20.

Due to the oscillating nature of the waves, the pressure and rate of flow of the hydraulic fluid through the turbine fluid supply conduit 26, and thus the rotational mechanical energy provided by the Pelton wheel 20 varies periodically over each wave cycle. Furthermore, the average rotational mechanical energy provided by the Pelton wheel 20 varies in the longer term as the wave environment varies.

The controller 28 is configured to monitor the variation in power provided by the Pelton wheel 20 with time and varies the power applied by the electric motor 17 in dependence on that variation. The controller 28 monitors the variation in power produced by the Pelton wheel using the sensors (not shown) which either measure the power directly or measure one or more parameters that are representative of or associated with the power produced by the Pelton wheel (for example, the pressure of the fluid in the turbine fluid supply conduit and/or the rate of rotation of the Pelton wheel).

In one mode of operation, the controller 28 varies the power applied by the electric motor 17 in order to make up any shortfall in the power provided by the Pelton wheel 20 so as to maintain the rate of operation of the pump 4 at a desired level, or within a desired range. In turn, that can ensure that the feed pressure to the membranes of the reverse osmosis device 2 remains substantially constant at the desired pressure, which can ensure a steady and substantially constant supply of desalinated water of suitable quality.

The controller 28 is also operable to selectively connect the Pelton wheel 20 and generator 27 via the clutch arrangement 29 to drive operation of the generator 27. The controller 28 is configured to control operation so that any excess power provided during each wave cycle by the Pelton wheel 20, greater than the power required to drive operation of the pump, is used to drive the electrical power generator 27. In variants of the embodiment, the Pelton wheel 20 can be temporarily disconnected from the drive shaft 18 under control of the controller 28 during periods when it is providing more power than required by the pump.

The controller 28 may also be configured to take into account operating limits of the motor 17 or the Pelton wheel 20 in varying the power applied by the motor 17 or the Pelton wheel 20. So, for example, if the motor 17 has a maximum ramp rate, the controller 28 may be configured to control the power applied by the motor to ensure that the ramp rate is not exceeded.

The efficiency of operation of the electric motor 17 is around 90%, the efficiency of the Pelton wheel 20 is around 88% and the efficiency of the high pressure pump 4 is around 75%. That provides an overall efficiency of around 60%. In theory, higher efficiency could be obtained by using the wave power device 24 to provide pressurized sea-water directly to the reverse osmosis device 2, rather than using the turbine to convert the wave power to rotational mechanical energy, but in practice the operational difficulties, and the economic and technical difficulties in implementing such a system would outweigh any theoretical efficiency gains.

In the embodiment of FIG. 1, the turbine is in the form of a Pelton wheel 20 but other turbines, in particular hydraulic turbines, may be used instead of the Pelton wheel 20 in some embodiments.

Hydraulic turbines are machines designed to convert hydraulic to mechanical energy. There are three main categories of hydraulic turbines, the Kaplan Turbine (essentially a propeller designed to operate in a duct), an axial flow turbine (a reverse running pump) and an impulse reaction turbine. A Pelton wheel is an example of an impulse reaction turbine. The three turbine types attain their peak efficiency and performance when operating at very low, medium and high pressures respectively.

In embodiments such as that of FIG. 1, in which a vertical flap device is used as a wave energy conversion device, pressures are expected to be in excess of 25 bar and an impulse reaction turbine, in particular a Pelton wheel, has been found to be the most suitable device. Pelton wheels have previously been used to recover energy from the pressurized brine by-product of desalination plants.

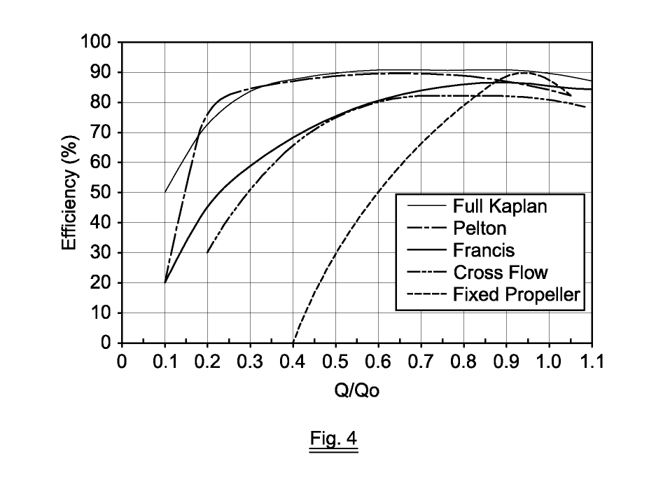

The Pelton wheel has a simple construction and directly produces rotational energy. Furthermore, the Pelton wheel can perform at very high efficiencies, for example around 88%, and maintain that level of efficiency for a wide range of flows, even down to 30% of the design flow of the wheel. A graph of variation of efficiency with flow rate is shown in FIG. 4.

The power derived from a Pelton wheel is proportional to the product of the head and flow and hence varies with the pressure of the fluid provided by the wave energy conversion device via the turbine fluid supply conduit. The size of a Pelton wheel is sensitive to the bucket width, the jet diameter and the ratio of the wheel diameter and the jet diameter and these parameters, when taken into consideration for a wheel design will favor the operation at high pressures, usually beyond 150 m. Variations in pressure cause a variation in energy output.

The wave energy conversion device is also not limited to the vertical flap device shown in FIG. 1, and any suitable wave energy conversion device can be used that provides for the conversion of wave energy to rotational mechanical energy, either directly or by pressurizing fluid to drive operation of a turbine. Examples of wave energy conversion devices that may be used in alternative embodiments include floating devices such as buoy devices, and articulated link devices or submerged, oscillating flap devices.

The system of FIG. 1 may be entirely purpose built. However, it may also be produced by retrofitting or otherwise adapting the wave power system 22, including the wave energy conversion device 24 and the Pelton wheel 20, to an existing desalination plant comprising the motor 17, high pressure pump 4 and reverse osmosis device 2.

In adapting an existing plant, the Pelton wheel 20 may be coupled to existing equipment in the plant. It has been found that the most straightforward and economical way of doing so is to insert the Pelton wheel 20 in between an existing high pressure pump 4 and an existing electric motor 17. The Pelton wheel 20 can be manufactured with a double ended shaft to fit the existing high pressure pump 4 and existing drive shaft 18 thus saving the replacement of either the pump or shaft. The rest of the installation such as the piping, membranes, ERT, and high pressure pump are able to remain substantially intact. The only significant requirement is for the foundations of the Pelton wheel 20 and in some cases the repositioning of the motor 17. Electrical and control systems for the pump 4 and motor 17 can remain substantially untouched. Such an arrangement can ensure a minimum of interruption time during the equipment installation, which may be expected to be an important feature for the plant operator.

In contrast, converting an existing reverse osmosis plant to receive pressurized water directly from a wave energy system (rather than using a wave energy system and turbine to provide mechanical energy to drive a pump) would require a prolonged plant shutdown for the conversion process and suspending the water production during this period would a very sensitive issue in dry areas.

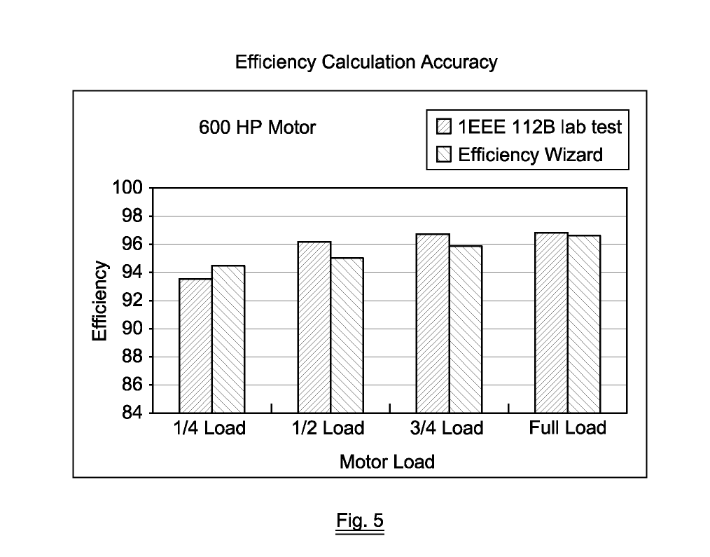

The energy provided by the Pelton wheel 20 reduces the load on the existing electric motor 17, which drives the high pressure pump 4. Presuming, in the case of retrofitting, that the motor has been selected to have a power rating optimized for an expected load in the absence of the Pelton wheel 20, it is likely that the motor will have to operate below its designed power rating. The effect of this reduced power on the motor may be a reduction in its efficiency. However, published technical data on induction motor performance on reduced loads indicates that for high capacity motors any reduction in efficiency is not likely to be significant. For example, FIG. 5 shows the expected variation in efficiency with variation in load of a 600 HP (500 kW) motor tested under two different test regimes, including the IEEE 112b test standard.

Retaining the same motor 17 can ensure that the plant will run at the designed pressure and flow since any loss of power from the Pelton wheel 20, as a result of low pressure form the wave power system 22 would be compensated by the motor 17.

In extreme cases, operation of the high pressure pump 4 may be driven solely by the Pelton wheel 20 or solely by the motor 17. It can be determined whether it is more beneficial to operate a given existing desalination plant with a Pelton wheel 20 designed to provide all power or designed to provide a given percentage of the power, with the remaining power provided by the electric motor, by taking into consideration the expected motor efficiency at reduced loads and the expected frequency and magnitude in variations in pressure of the fluid provided to the Pelton wheel 20.

It can be seen that wave energy does lend itself to replacing grid power on desalination plants, if implemented appropriately. In the embodiments described above, modifications to a desalination plant can merely involve the addition of a Pelton wheel on the shaft of the high-pressure pump, and the resulting system can cope with any variation in the availability of wave energy from 0-100%. Furthermore, desalination plant operators are familiar with Pelton wheel technology as it has been used previously to recover the energy from the brine discharge from reverse osmosis devices, and it can be readily applied to new plants and virtually all existing plants.

It will be understood that the present invention has been described above purely by way of example, and modifications of detail can be made within the scope of the invention.

Each feature disclosed in the description, and (where appropriate) the claims and drawings may be provided independently or in any appropriate combination.

1. A desalination system comprising a reverse osmosis device, a pump for pressurizing fluid to be desalinated, a supply conduit for supplying the pressurized fluid to the reverse osmosis device, and a wave power system for driving operation of the pump, wherein the wave power system comprises:—
a turbine connectable to a transmission for driving operation of the pump and arranged such that in operation rotation of the turbine provides mechanical energy to the transmission to drive operation of the pump; and
a wave energy conversion device connectable to a turbine fluid supply conduit for supplying fluid to the turbine, wherein the wave energy conversion device is arranged to operate in response to wave motion to transfer fluid through the turbine fluid supply conduit to drive rotation of the turbine.

2. A system according to claim 1, further comprising a motor for at least partially driving operation of the pump.

3. A system according to claim 2, wherein the transmission is a common transmission for both the motor and the turbine, and both the motor and the turbine are operably connectable to the transmission.

4. A system according to claim 2, further comprising a controller for controlling the amount of power supplied to the pump by the motor and/or the amount of power supplied to the pump by the turbine.

5. A system according to claim 4, wherein the controller is configured to control the amount of power supplied by the motor to the pump and/or the amount of power supplied by the turbine to the pump to provide at least one of:—
a desired torque;
a desired rate of rotation of the pump;
a desired pressure of the pressurized fluid supplied to the reverse osmosis device;
a desired rate of flow of pressurized fluid to the reverse osmosis device.

6. A system according to claim 5, wherein each of the desired torque, the desired rate of rotation, the desired pressure and/or the desired rate of flow is substantially constant and/or is within a respective predetermined range.

7. A system according to claim 4, wherein the controller is configured to monitor the amount of power supplied to the pump by the turbine and/or to monitor the amount of power supplied to the pump by the motor.

8. A system according to claim 4, wherein the controller is configured to control the level of power supplied to the pump by one of the motor and the turbine to make up a shortfall in power supplied to the pump by the other of the motor and the turbine.

9. A system according to claim 4, wherein the controller is configured to control the level of power supplied by the motor and/or the turbine to ensure that the rate of change of power supplied by the motor and/or the turbine is within a predetermined threshold.

10. A system according to claim 1, further comprising an electrical generator that is operably connectable to the turbine to generate electricity from rotation of the turbine.

11. A system according to claim 10, wherein the controller is configured to connect the turbine to the electrical generator to generate electricity from excess rotational energy of the turbine.

12. A system according to claim 10, wherein the motor is configured to operate as the electrical generator.

13. A system according to claim 1, wherein the turbine comprises an impulse turbine.

14. A system according to claim 13, wherein the turbine comprises a Pelton wheel.

15. A system according to claim 1, further comprising a flywheel for storing rotational energy provided by the turbine.

16. A system according to claim 1, further comprising at least one control valve for controlling flow of fluid from the turbine fluid supply conduit to the turbine.

17. A system according to claim 16, wherein the at least one control valve comprises a variable opening control valve, and the system further comprises a flow controller for varying the opening of the variable opening control valve during each wave cycle.

18. A system according to claim 1, wherein the fluid supplied to the turbine is salinated fluid, the turbine comprises an output for expelling the salinated fluid, and the turbine output is connected to an input to the desalination system, whereby in operation salinated fluid expelled from the turbine is passed to the desalination system for desalination.

19. A method of desalination comprising using a wave energy conversion device to drive rotation of a turbine, and using mechanical energy from the turbine to drive operation of a pump to pressurize fluid to be desalinated.

20. A method of adapting a desalination system, the desalination system comprising a reverse osmosis device, a pump for pressurizing fluid to be desalinated, a supply conduit for supplying the pressurized fluid to the reverse osmosis device, and a motor for driving operation of the pump, wherein the method comprises:—
providing a turbine connectable to a transmission for driving operation of the pump and arranging the turbine such that in operation rotation of the turbine provides mechanical energy to the transmission to drive operation of the pump; and
providing a wave energy conversion device connectable to a turbine fluid supply conduit for supplying fluid to the turbine, and arranging the wave energy conversion device to operate in response to wave motion to transfer fluid through the turbine fluid supply conduit to drive rotation of the turbine.
